(19) United States
(12) Patent Application Publication
(10) Pub. No.: US 2016/0253093 A1
(43) Pub. Date: Sep. 1, 2016

(54) A new USB protocol based computer acceleration device using multi I/O channel SLC NAND and DRAM cache

(71) Applicant: Weijia ZHANG, Hangzhou, Zhejiang (CN)

(72) Inventor: WEIJIA ZHANG, HANGZHOU (CN)

(21) Appl. No.: 15/028,028

(22) PCT Filed: Sep. 28, 2014
(86) PCT No.: PCT/CN2014/087627

§ 371 Date: Apr. 8, 2016

(30) Foreign Application Priority Data
Oct. 13, 2013 (CN) 201310475462.4

(51) Int. Cl. G06F 3/06; G06F 13/42; G06F 12/08; G06F 13/28; G06F 9/44

(52) U.S. Cl. CPC G06F 3/061; G06F 13/28; G06F 3/0685; G06F 9/4413; G06F 12/0868; G06F 3/0631; G06F 3/0661; G06F 13/4282; G06F 12/0811; G06F 2212/2146; G06F 2212/217; G06F 2212/221; G06F 2212/283

(57) ABSTRACT

This study presents a new USB protocol based computer acceleration device that uses multi-channel single-level cell NAND type flash memory (SLC NAND) and Dynamic random-access memory (DRAM) cache. This device includes a main controller chip, at least one SLC NAND module, and a USB interface to connect the device to a computer. It then creates and assigns a cache file in SLC NAND and DRAM for the computer cache system, caches the common used applications, and read and pre-reads frequently used files. The device drive improves the USB protocol, optimizes the BOT protocol in the traditional USB interface protocol, and optimizes resource allocation for the USB transport protocol.

The algorithm and framework of the device employ the following design:
1. The device virtualizes the application programs for pre-storing all program files and the system environment files required by programs into the device.
2. The device works in multi I/O channel mode, an array module integrates an array of SLC NAND chips and uses main controller chip that can deal with multi I/O channel.
3. By monitoring long-term user habits, data that will be used by system can be estimated, and the data can be pre-stored in the device.
4. The device allows intelligent compression and automatic release of system memory in background.

### BACKGROUND OF THE INVENTION

This product is classified as computer performance improving equipment. It is a new computer acceleration device implementing a USB protocol, based on multi I/O channel SLC NAND arrays and DRAM caches.

Computers have rapidly evolved, and numerous product models, equipments, and complex system platforms have emerged. However, effective and universal upgrade solutions have yet to be developed.

1. Why do we need a universal computer acceleration product?

The development of technology is faster than that of hardware. For instance, HD Movies and Win 8 System, as well as some minimum game configuration, require a quad-core processor. Microsoft Office 2013 takes up a memory of 2 GB. Furthermore, upgrading computers costs a few hundred dollars. Upgrading is a difficult issue. In existing solutions, computers are generally replaced by a new machine. With this solution, money is spent and old machines are disposed. In some instances, users buy parts and replace components by themselves. However, replacing computer parts is very complex, and it requires specific skills. For example, various data cables must be accurately connected, data must be exported from an old hard drive, and system and various software & drivers must be reinstalled. Changing the CPU or swapping hard drives is also a challenging task for general users.

Some software types, such as “360 optimization” and “speed ball”, can be used to optimize computer systems, but these software types are unable to improve the hardware. They merely clean up unnecessary files from computer systems. It is similar to some cases users believe that the speed of computers increases after the system being rebooted or reinstalled. However, such software are unable to really enhance the performance of computers.

2. What is the bottleneck of computer speed?

In many cases, computer speed is determined by hard drive speed, especially the speed of accessing frequent read and write files and the speed of random read and write (r/w) of small files.

In the past decade, CPU and memory performances have improved 100 times, but hard disk performance has been enhanced by only threefold. As such, the hard disk is the main issue of accelerating data processing. Information can be transmitted along a “highway” if this issue has been resolved.

For this reason, solid state drives (SSDs) are used to replace mechanical hard disks. SSDs are hard drives arrayed by solid state electronic memory chips, with a control unit and storage units. SSD is consistent with general hard drives in terms of interface specification, and product shape and size. The main kind of SSD is flash-based solid state drive with a very simple internal structure. The internal body of a SSD is composed of a PCB board, which comprises basic accessories, including control chip, cache chips (although some low-end SSDs do not contain cache chips), and flash memory chips for data storage. In addition to the main chip and cache chips, NAND flash memory chips constitute the SSD PCB.

SSDs are characterized by quick start, excellent shock resistance, and absence of motor and rotating media required by ordinary hard drives. SSDs do not have read/write heads; as such, the disk read and write speeds are faster, and latency is very low. The read and write speed can generally reach more than 100 MB per second.

Although SSDs are faster than mechanical hard drives (HDDs), the former provide many disadvantages, such as costly, small capacity, and limited write endurance. Furthermore, the price per GB of SSDs is much more expensive than the cost per GB of HDDs. Therefore, SSDs are unsuitable replacements for mechanical hard drives in new computers.

Feasibility and cost effectiveness must be considered before old computers are upgraded. Compatibility issues must also be accounted for. Early motherboards do not support SSDs, because they do not support the SATA 2 or SATA3 agreements. The board interface with an ordinary IDE or SATA hard drive protocol supports a maximum speed of 100 MB per second. For these reasons, the acceleration effect is unlikely obtained by simply using SSD. Upgrading computers is also inconvenient because users must exhibit technical skills to replace hard disks by themselves. Upgrading computers also requires replacing the entire system, copying all previously saved files, and reinstalling various drivers and software. Furthermore, installing SSD is complex, including settings such as Trim command, 4k alignment, and ACHI.

3. Are there other cost-effective and more convenient technical solutions to solve disk speed issues?

A few other devices are used to increase computer speed. For instance, Intel Turbo is an expansion card with a PCI-E interface equipped with one or two MLC NAND flash memory. As a mini PCI-E expansion card, Intel Turbo conducts data exchange via the PCI-E bus and the System I/O controller.

Under the support of Windows system, Intel Turbo can provide ReadyBoost and ReadyDrive features that directly enhance the performance of the system in terms of startup, sleep, program installation, copying files, loading games, and other processes. Turbo can increase computer speed by 20% during start up, with low hard disk revolutions and power-saving features.

ReadyBoost Features:

ReadyBoost is a disk caching software component developed by Microsoft for Windows Vista and included in later versions of the Windows operating system. ReadyBoost enables NAND memory mass storage devices, including CompactFlash, SD cards, and USB flash drives, to be used as a write cache between a hard drive and random access memory in an effort to increase computing performance. ReadyBoost relies on the SuperFetch technology and, like SuperFetch, adjusts its cache based on user activity.

ReadyDriver Features:

ReadyDrive is a feature of Windows Vista that enables Windows Vista computers equipped with a hybrid drive or other flash memory caches (such as Intel Turbo Memory) to boot up faster, resume from hibernation in less time, and preserve battery power. Hybrid hard drives are a new type of hard disk that integrates non-volatile flash memory with a traditional hard drive. The drive-side functionality is expected to be standardized in ATA-8. When a hybrid hard drive is installed in a Windows Vista machine, the operating system will display a new “NV Cache” property tab as part of the drive's device properties within the Device Manager.

As can be seen from the Turbo driver instruction, users can set ReadyBoost and Ready Drive functions in their software interface.

However, Turbo memory is still not a good upgrade solution. The main reasons for its failure: 1. It cannot be used for desktops and most notebooks. All netbooks and most laptops do not support Turbo Memory module, as it not only requires a Mini PCI-E slot, but more importantly, also requires AHCI support; 2. Installation is complex as many users do not know how to open their laptop cases and how to install Turbo memory to mini PCI-E; 3. PCI-E bus speed itself is limited to 150 MB per second and Intel's flash memory's speed is even far less than that. It is in fact only 35 MB per second of random read and write speed; 4. Expensive. 4 GB Turbo memory costs about $100; 5. Poor system compatibility. Readydrive or Readyboost can only be used for operating system advanced than Windows Vista while the vast majority of older computer operating systems are XP.

### SUMMARY OF THE INVENTION

The present invention provides a method of manufacturing a computer cache device to improve the speed of existing computers for simple and reliable upgrade purposes. Compared with prior techniques, the method presented herein increases the durability and random read and write speeds of the cache to optimize the r/w operation, achieve a multi-level cache hierarchy, and using a convenient USB interface.

In this invention, an external hardware device based on multi-channel parallel computing SLC NAND flash memory specifically designed for computer acceleration is employed. To effectively improve the performance of old computers and fulfill the need for simple installation/use, the invention adopts the following schemes: plug and play USB interface (broad USB interface, including ordinary, mini, and micro USB) and electronic devices, including a main chip and SLC NAND flash memory module (or simulate SLC working conditions with MLC NAND such as SLC NAND flash memory which is based on the improvement of MLC NAND products. Through a specific flash management algorithm, 2-bit per cell of MLC NAND is reprogrammed to 1-bit per cell iSLC, thereby allowing MLC NAND to become close to SLC NAND.) Generally, the device comprises a plurality of parallel computing SLC modules and a plurality of master controller ICs or a multi-channel to achieve an effect similar to that of Redundant Array of Independent Disks (RAID). The operating principle of the device consists of two aspects. First, the device is connected to a computer through a USB interface. In the device memory, a cache file is created to cache common files of the system and applications, and cache-ahead frequently read and write fragmented files, taking advantage of high-speed random access and fast read and write speeds of the memory device. The computer system's access to the hard disk (including NAND-based SSDs) is thus reduced to provide acceleration and enhance I/O performance.

Second, given that the speed of SLC is significantly limited in USB2.0 mode and the read and write operations of NAND are imbalanced, e.g. the write operation consumption is almost eight times the consumption of the reading operation, therefore, the device uses DRAM cache as an agile cache. This can be achieved in two ways. First option, the device comes with DRAM cache as a mapping table and a data cache (for example, 1 GB of SLC NAND per 1 MB of DRAM cache). Second option, the host computer's memory cache is called when a cache is created. A divided portion of the host computer memory and SLC NAND caches of the device is composed together to create a high-speed cache area. The NAND write operation is nearly eight times the read operation because of the large differences between read and write in terms of consumption. Therefore, write consumption should be assigned to the multiple DRAM layer; in this way, enough DRAM cache can be ensured. In fact, users utilize the read operation much more often than the write operation. Therefore, it is reasonable to set DRAM as the L1 cache and NAND as the L2 cache. These two methods can be utilized alone or in combination.

Meanwhile, the device driver improves the USB protocol, optimizes the bulk-only transport (BOT) protocol that hinders rapid data transfer in the traditional USB interface, and optimizes the allocation of resources to the USB transfer protocol. More system resources are configured to the device, and support for the multi-tasking transmission function is provided, similar to Native Command Queuing (NCQ). Lastly, the random read and write speeds are improved under multi tasks.

The algorithm and architecture of the device may also adopt the following design. First, an intelligent compression of system memory and automatic-release the system memory at background are provided, in order to avoid increasing the hard disk read and write while calling the virtual memory because of insufficient computer memory. Second, through a long-term monitoring of user habits, the device guesses what part of data the system is about to use, and these data are pre-stored in the SLC NAND flash memory of the device. The CPU obtains the data directly from the device and then transfers them to the host RAM memory, thus reducing the host hard disk read and write. Third, if in dual channel mode, the array module integrates two SLC NAND flash memory chips with the dual-channel master controller, which can operate in dual channel mode. As a logical disk group, the data are stored in a segment manner on different physical disks. When the data are accessed, the related disk array works in parallel mode, thereby reducing the time of data access, to achieve the same acceleration effect as RAID 0; the read and write speeds are also increased. The performance bottlenecks of solid state memory are usually on the inside of the core. Parallel access on the system level or device level can improve these bottlenecks.

Another important point is that the device virtualizes he application to make almost all application program files and program system environment files pre-stored on the device. Many virtualization methods can be used. The main one is using sandbox virtualization technology. In this technology, the application is installed, and all the actions are recorded as local files. When executing the main program file, a temporary virtual environment is generated to perform, similar to a shadow system. All operations involved are completed in this virtual environment and do not involve the original system. After this process, all call files are stored in the application's directory, which is in the SLC NAND flash memory module, and will not be installed on the hard disk. The purpose is to achieve fast program operation, simple installation and operation, the capability to run a powerful system, and the compatibility to run a wide range of system programs. The application can operate in high-speed, plug and play directly on a host computer without installation. The device could also import the application to the host as files or data. This approach also reduces the system service processed, reduces especially the scheduled tasks, add-ons & extension, boot time, resulting in enhanced system application functionality and system optimization.

The device scheme is shown in FIG. 1. The device can be utilized on a computer with XP, Vista, Win7, Win8, or other Windows operating systems as long as the computer has a USB interface.

The instructions for several key issues are as follows.

1. Why use SLC NAND caching and parallel technology rather than mere DRAM cache?

First, if only DRAM cache is applied, with current technical capabilities, it can generally achieve a cache capacity of 1 MB: 1 GB because of limited DRAM cache. Second, with DRAM as the mapping table, the mapping table on the particles is loaded into the cache in the first time before the self-test. This is a highly efficient way of increasing speed to rewrite it back to particles when updating, provided that the thrust reverser repair algorithm of the mapping table within the firmware works well after power. Otherwise, it will result in the risk of disk loss and a high technical risk. Finally, the main drawback of cache is that it needs information read of the cache to construct the index, which introduces additional read transactions and increases the system overhead, thereby making the circuit highly complex and the power consumption large. If a field programmable gate array or a partial cache of flash is used to accelerate the read and write operations, then the cache resources are insufficient for the entire system and the entire schedule, resulting in frequent failure buffer and increased system response time.

2. Why use the external USB interface instead of the internal SATA interface?

Obviously, USB plug and play is the most convenient and easiest mode. It is compatible with almost all computers because almost all computers have USB interfaces. Any internal interface that is not easy to use will not be adopted by the society. Thus, will the speed of the USB interface affected the performance? The answer is discussed below.

For computers manufactured before 2009, the USB interface is typically USB 2.0, and the speed bandwidth is 480 MB per second, corresponding to a maximum data transfer of 60 MB per second. This value appears to be small. However, computers before 2009 do not have SSDs, and the random data access speed of a general mechanical hard disk is less than 20 MB per second or usually around 10 MB per second, which is far below the 60 MB bandwidth of the USB2.0 mode. As long as the USB protocol is optimized as much as possible to full speed, it can accelerate to nearly 6 times. In the actual production samples described below, the random r/w speed reaches 44 MB to 50 MB per second on USB2.0 computers.

Computers with USB3.0 are faster than those with SATA. USB 3.0 provides 5 Gbps (625 MB/s). Although the SATA III bandwidth is 6 Gbps, it will be only 600 MB/s after conversion because the transmission architecture conversion is not the same. It is less than USB 3.0′s 625 MB/s in theoretical value, not to mention the SATA II's 3Gbps (300 MB/s).From the perspective of convenience, USB is indispensable for each computer port. USB 3.0 is not only backward compatible with plug and play, but it also has a considerable advantage: the power supply is increased from 500 mA to 900 mA.

3. Why does it modify the USB protocol?

USB in the past exhibited a very serious problem of low bandwidth utilization. The bandwidth of USB 2.0 is 480 Mbps (60 MB/s). However, even USB flash drives with an actual transfer speed of up to 100 MB/s or more cannot use the full bandwidth; the maximum speed is approximately 33 MB/s, which is only about half. This is because of the half-duplex transmission mode of USB and BOT transport protocol. Half-duplex data transmission is similar to a walkie-talkie. When one party presses the speaker button, the other party can only hear the sound. The latter must wait until the former finishes speaking, which means the half duplex mode provides a two-way data transmission function but the data transmission direction is only one-way. The BOT transport protocol is a single-threaded transmission architecture. One cannot send another packet of data until a complete block of data is served; that means no matter how wide this road is, it can only allow one car to travel. This manner cannot effectively alleviate the huge rear traffic and will result in a data block “traffic jam” situation. When the USB is upgraded to 3.0 specifications, despite the use of additional five contacts instead of the full-duplex data transmission mode, two-way data transmission is realized simultaneously. Compared with that of the previous generation, the current bandwidth is improved by as much as ten times. However, its transmission infrastructure is still under BOT, so acceleration must be optimized.

The BOT acceleration mode is easy to understand in the above mentioned analogy. Under the BOT structure, only one car can drive on the road. A person in a car is one, a small bus filled with five people is one, and a large passenger bus filled with 50 people is still one. The amount of traffic will be reduced if the large passenger bus is used every time a certain number of persons need to be transported. The USB turbo mode is designed based on this principle. The data are compiled into large data blocks and then transmitted. Regardless of storage media, the ability to handle large files should always be better than that for handling small files. This is why this approach can significantly improve the data transfer speed.

4. Why does it virtualizes system programs?

Virtualization means to virtualize the system environment into a series of files and load at software runtime. All read and write operations required to run programs are transferred to the virtualized program directory, which is in the external SLC NAND flash memory chip. The host HDD read and write are no longer required. For this device, the computer's hard drive host system will no longer run the virtualized program files or virtualized program calls, all of which are loaded from an external SLC NAND flash memory. In addition, the accelerated computer's hard drive will no longer run the virtualized program files or system files; all of these are run in the external SLC NAND flash memory chip. This process thoroughly avoids the hard disk read and write. Otherwise, running applications will still be inevitable to access the hard drive.

The purpose is to achieve fast program operation, simple installation and operation, the capability to run powerful systems, and the compatibility to run a wide range of system programs. Thus, the application can directly operate in high-speed plug and play on a host computer without installation. The device could also import the application to the host as files or data. This approach also reduces the system service processed, reduces especially the scheduled tasks, add-ons & extension, boot time, resulting in enhanced system application functionality and system optimization.

Advantageous Effects: Compared with traditional computer upgrade, the device has the following advantages.

1. Simple operation. Upgrading old computers often requires computer disassemble to change the memory and the hard drive. To increase the speed of the computer, a motherboard needs to be welded to change the CPU, which often results in a poor condition or even a blue screen for non-skilled users. Compatibility among various interfaces is too difficult for most users to understand. The most appropriate means is to bring the computer to a computer shop for upgrading. However, this situation entails a high cost, and several parts are even missing or replaced after repair. With the proposed device, an individual only needs to make a few clicks to complete the acceleration after installing drivers and plug the device into the computer.

2. Improved effect. For USB 2.0 computers with an ordinary mechanical hard drive, the speed can increase by 3 to 6 times when the program starts running. For USB 3.0 computers with a new mechanical hard drive or a hybrid hard drive, the speed increases by 10 to 20 times. For USB 3.0 computers with SSD, the speed can still increase by 2 to 3 times. In addition, ordinary computers can be converted to USB3.0 from the PCI-E or ExpressCard. Compared with the original USB3.0, the converted USB3.0 has a lower speed, with a data transmission speed of approximately 150 MB per second. Thus, old computers can also use USB3.0.

3. Low cost. The production cost of the dual-channel SLC NAND flash memory and the latest dual-channel master controller is less than 100 Yuan (15 US Dollar).

Preferred embodiment of the present invention:

According to the current market equipment and techniques, at a reasonable cost range, one of the best embodiments of the present invention is as follows.

The design employs USB 3.0 or 3.1 interfaces, SandForce master controller, 1 GB on board DRAM cache, 8 SLC NAND chip (8 GB each) to form a eight-channel SLC NAND memory module (64 GB), and uses multi-level cache design. Level 2 (L2) cache is the 8-channel slc nand, while level 1 (L1) contains 2 set of DRAM cache (The device assigns DRAM cache in accordance with NAND:DRAM ratio of 64:1. At the same time, the host computer DRAM cache is called in accordance with NAND:DRAM ratio of 8:1.The section called from the host computer creates a RAM disk cache, generating a image files to save and load when switching off/on the machine). The device creates and assigns cache files in SLC NAND and DRAM, caching common r/w files of the host system and applications, and pre-reading fragmented files that are frequently read and written by the computer. Considering that the write operation's consumption of flash memory is about eight times the consumption of the read operation, and for ordinary users, the read operation is much more often than the write operation, it assigns the write operations cache, especially small file write operations cache, into the DRAM cache, including write operations such as web browsing, while assigning read operations cache, especially random read operation, into the NAND cache, including read operations such as loading a game or a program. It also has a console, in which user can complete program preloading, memory compression, and acceleration of the focusing procedure manually. A specially prepared browser based on the device cache mechanism is introduced or can be pre-embedded to realize focused acceleration on network applications (Modern users increasingly use the browser and web-based applications).

The algorithms and architecture of the device also employ the following design. First, the device creates a virtual environment for application virtualization. All program files and required system environment files are pre-stored into the device to improve the cache hit rate. Second, the algorithm is pre-stored by long-term monitoring of user habits. The data the system is about to use are determined and then pre-stored in the device. Third, the device provides intelligent compression and automatic release in the background for the system memory.

Meanwhile, the device improves the USB protocol, optimizes the BOT agreement in the traditional USB interface protocol, and optimizes the allocation of resources in the USB transfer protocol.

Based on the current market equipment and techniques, at a reasonable cost range, it is one of the best embodiments of this invention. It does not limit the scope of patent protection. The skilled personnel structure should be modified within the scope of the present invention. Structural modifications made by persons skilled in the art should be within the scope of the present invention.

### BRIEF DESCRIPTION OF THE DRAWINGS

FIG. 1. Schematic plot of the device.

FIG. 2. Effect of sample devices, device with USB2 reads cache at the speed of 44 MB per second (bottom), after the DRAM write optimization, the overall cache speed achieves 60 MB per second.

FIG. 3. Sample device operating instruction, USB plug and play.

FIG. 4. Accelerated memory console interface when using a sample device.

FIG. 5. SLC NAND chips and circuit board diagram of sample devices.

FIG. 6. The schematic diagram of the triple caching of sample device.

FIG. 7. Startup menu of virtualized program in the sample device, and is managed through a control center.

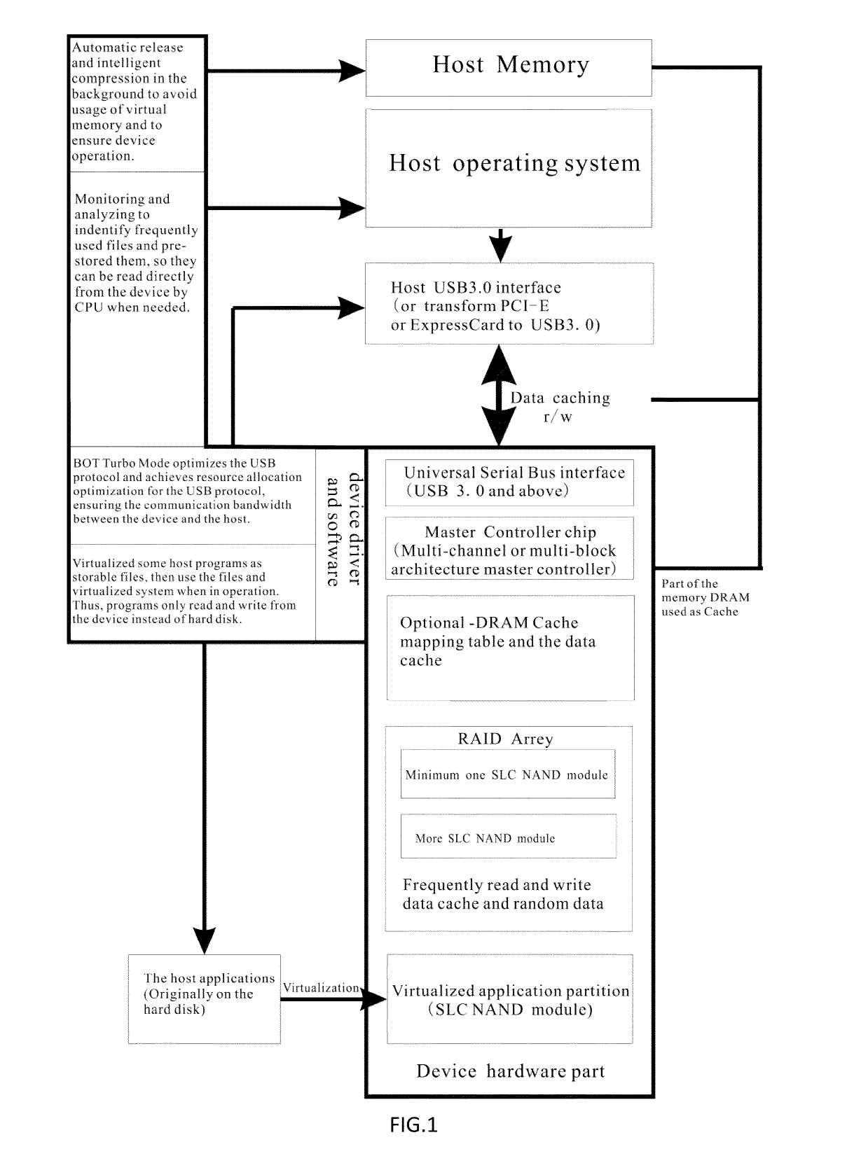

### DETAILED DESCRIPTION OF THE INVENT ION

Embodiments of the present invention:

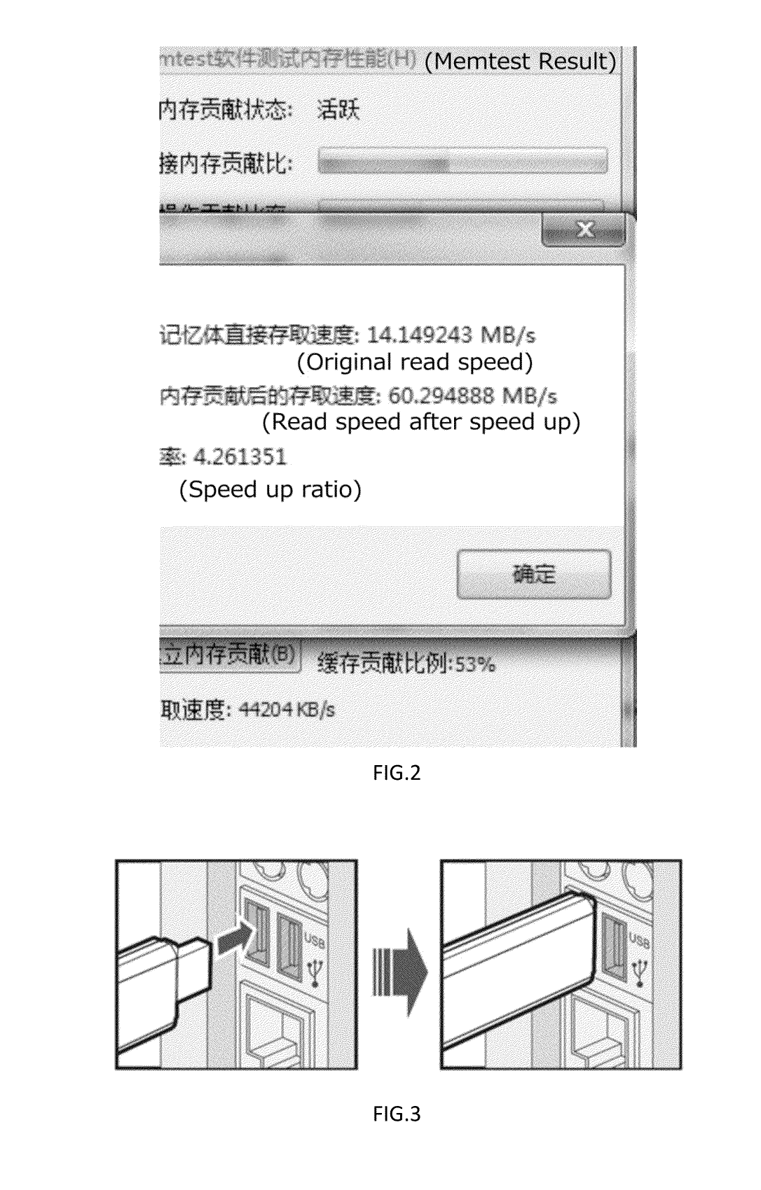

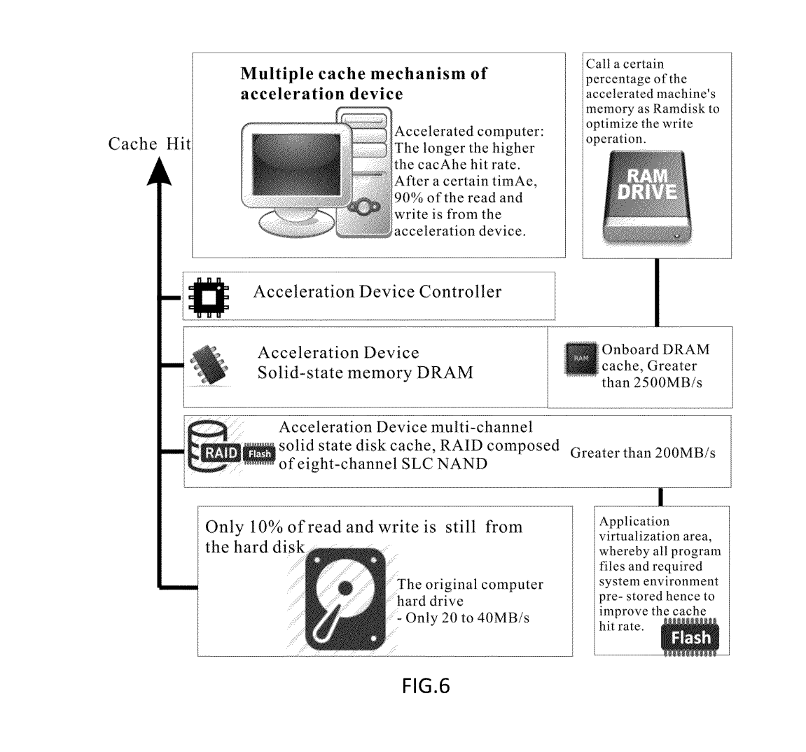

The present invention has produced a batch of samples for practical production. Divided into high-end and low-end versions, high-end version is described above as the preferred embodiment. To take into account the cost and performance, the low-end version is preloaded with double-side dual-channel SLC NAND memory modules with 16 GB cache area as main cache. According to a 1000:1 ratio provide onboard 16 MB of DRAM, and with high-speed communication according to the USB3.0 interface it works as a random storage in the local system to accelerate and improve cache performance. In the USB3.0 interface, the test read speed is 260 MB per second, and the write speed is 240 MB per second, which is twice of the SSD speed. The speed of 4 K random read and write reaches 40-50 MB per second even when under the USB2.0 protocol. The I/O and random read and write performance are far better than those of mechanical hard drives (as shown in FIGS. 2 and 6).

The device transfers part of the system memory and uses it to constitute a complex cache with SLC NAND. In addition to the dual-channel SLC NAND cache formed according to parallel technologies, the device calls on some of the computer's DRAM memory (users can decide how much, but the device will calculate and suggest values) as the mapping table and a high-speed cache area. Also on the SLC NAND part, 8 GB SLC NAND is created as a cache for random data and files frequently read and written, and the rest of the 8 GB of SLC NAND serves as vir tua lization program storage and mounting area.

On SLC NAND partition, there is a portable Windows virtual environment. The device virtualizes application to pre-store program files and required system environment files into device.

After the device being connected to a computer, the USB protocol is automatically optimized to achieve BOT turbo mode. It allocates more resources to the device. After changing the USB transfer protocol, it becomes able to handle mult iple read and write caching tasks simultaneously instead of cache exchange only in a single line (similar to e.g., hard drive NCQ technology), thereby, allowing the device to fully play the role of new system memory. Before optimization, the read capacity of USB3.0 is 190 MB per second, and the write capacity is 200 MB per second. After optimization, both are more than 250 MB per second, thereby showing the importance of this work.

The algorithm and architecture of the device include (1) provision of intelligent compression and automatic release in the background for the system memory, (2) determining what data the system is about to use and pre-storing them in the device by long-term monitoring of user habits, dual channel mode, SandForce master controller in high-end version (In the past this master controller is only be used for high-end version solid-state drives), Innostor IS903 master controller in low-end version, array module integrated withtwo 8 G Micron SLC NAND chips, and dual-channel master controller are employed.

The user only needs to insert the device into a computer and install the drive to open the abovementioned functions (see FIG. 3).

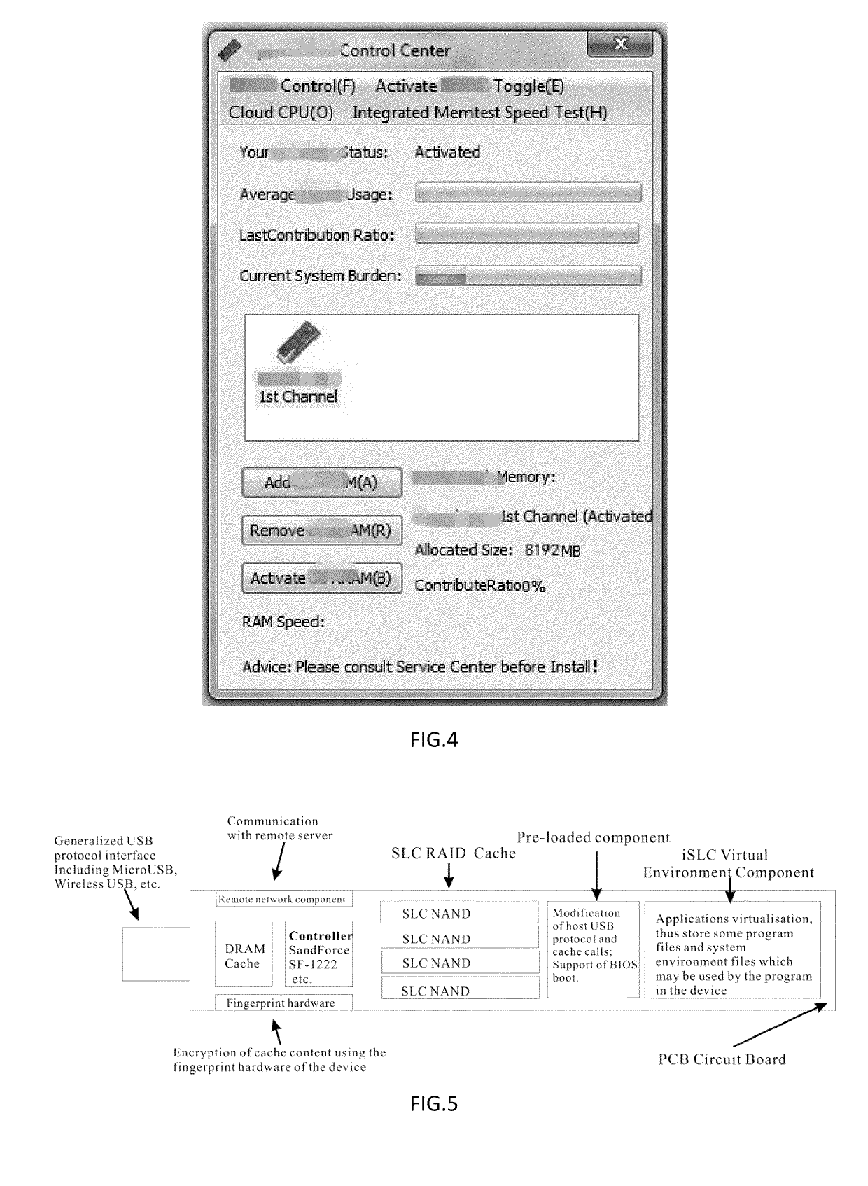

The device also has a graphical interface console that provides intelligent automatic control and management. Users can selectively load acceleration I/O channels (see FIG. 4). It temporarily withholds the name of the product prepared. An additional external cache can be viewed and managed through the control panel. Additional details are described below.

1. Two Kinds of Cache Material Used on Samples

NAND: Two 8 GB Micron DDR SLC NAND chips, which are SLC DDR synchronous flash memory, using single [SLC-8K] are employed. FIG. 5 shows the SLC NAND chip and a circuit diagram of the sample device. Gold immersion process and four-Layer USB differential impedance PCB are implemented to ensure good USB signal transmission. Others include power IC employing DC/DC converters, high-quality SMD crystal, nickel-plated USB plug after 24 h salt spray testing, working temperature of 0° to 60° C., and storage temperature of −20° C. to 0° C.

DRAM: 16 MB DRAM high quality memory chips particles, SOP packaged, industrial adapt temperature (−40° C.˜+85° C.)

2. Samples' Multichannel Architectures (FIG. 5)

SandForce master controller is used. In the past, this master controller was only used for high-end solid-state drives; low-end version samples used the Innostor 6903 master controller chip. The high-end version sample is described above as the preferred embodiment. In the low-end version sample, the device employs the Innostor IS903 dual channel chip equipped with two 8 GB SLC NAND memory modules belonging to the double-sided dual-channel scheme (see FIG. 6). Using USB3.0 interface, the test read speed is 260 MB per second, written as 240 MB per second, more than the speed of SSDs, able to accelerate the latest computer. Using USB2.0 interface, the device cache reaches a random 4K r/w speed of 44 MB per second (FIG. 6 bottom). After write optimization of DRAM, the overall speed of cache reaches 60 MB per second. Due to PC with the USB2.0 generally equipped with mechanical hard disk, whose random data rate is usually only 10-15 MB per second, getting three times faster for system means acceleration effect is very obvious. If old computers with USB2.0 and mechanical hard drive can be upgraded to USB3 by a PCMCIA Express Card, it can get 10× speed.

3. Sample Caching Mechanism

The high-end version is equipped with a 1 GB DRAM memory on-board chip and 8 pieces of 8 GB SLC NAND chips. The 8-channel SLC NAND memory module has a total memory of 64 GB. The module has a multiple hierarchical cache design, and the bottom L2 comprises an eight-channel SLC NAND cache. A high-speed L1 layer consists of two groups of DRAM caches. In the device, it assigns DRAM cache in accordance with a NAND:DRAM ratio of 64:1 while calling the host computer DRAM cache in accordance with a NAND:DRAM ratio of 8:1. The section called from the host computer mimics a RAM disk cache. In the low-end version, in addition to the dual-channel SLC NAND cache and the 16 MB DRAM cache formed according to parallel technologies, the device utilizes some of the computer's 128 MB DRAM memory as the mapping table and a high-speed cache area. Eight-gigabyte SLC NAND is used as a cache for random data and files that are read and written frequently; the remaining 8 GB of SLC NAND is used as a virtual program storage and mounting area. In the DRAM cache operations, we use a fast caching algorithm optimized for write operations to obtain a high I/O speed. It can reach several GB per second. In the SLC NAND second-level cache operations, the current algorithm of this sample is rewritten based on the traditional disk cache. Unlike the traditional cache, however, we perform two optimizations for the device. First, the conventional caching algorithm itself does not consider achieving parallelism in realtime; all requests are serialized. However, our device is a multi I/O channel parallel device, and it can improve I/O performance to transform the serial I/O into parallel I/O. We use modern multi-threaded programming to turn the serial I/O to parallel I/O using a fine-grained synchronization lock mechanism to increase the parallelism of the I/O process, thereby improving I/O performance. Second, the conventional caching algorithm does not distinguish between I/O types when caching disk data, in which requests are cached in the same manner regardless of whether I/O is random or sequential. In fact, our SLC NAND cache part is most effective at random readings of I/O, while DRAM is most effective at writing cache and 4K cache. Therefore our device determines the character of the I/O process; assign more random I/O requests in particular read request to cache in the SLC NAND. On a USB 3.0 device, even only the multi-way SLC NAND part could reach speeds of hundreds of MB per second.

4. Sample Virtualization Solutions

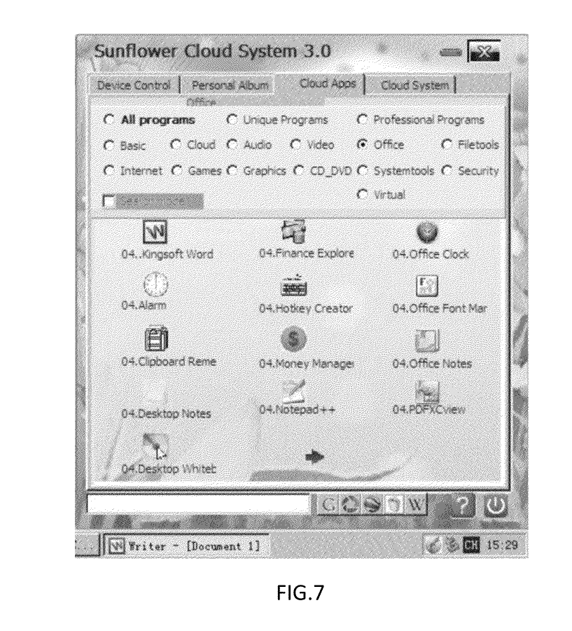

Samples have a virtual Windows environment, and users can directly use thousands of virtualized common software preloaded in the device or virtualize native applications to pre-store all program files and program system environment files into the device, as shown in FIG. 7. The virtualization principle has been elaborated mainly using the sandbox virtualization technology. First, we install the application and all the actions are recorded together as local files. When executing the main program file, it will generate a temporary virtual environment to perform, similar to a shadow system. All operations involved are completed in this virtual environment without affecting the original system. After this process, all call files are stored in the application's directory, which is in the SLC NAND flash memory module, and will not be installed to the hard disk.

The above-described embodiments of the present invention are intended to be illustrative only. Numerous alternative embodiments may be devised by those skilled in the art without departing from the scope of the claims.

### INDUSTRIAL APPLICABILITY

The performance of today's computers is mainly dependent on I/O performance. In accordance with the current industrial level and the foreseeable future technology growth, SLC and iSLC flash memory are likely to be produced on a wide and massive scale. Combined with DRAM cache and the parallel multi I/O channel scheme, SLC and iSLC flash memory can act as a multi-level cache for a computer to enhance speed and protect the life of a drive. This invention maximizes read and write performance, especially random read and write performance, and will be an important new device that can be applied widely. Notably, the consumption of flash read and write operations is different. The flash can maximize its read speed combined with a DRAM cache and parallel multi I/O channel scheme. It can assign a considerable amount of write consumption, especially frequent write consumption, of small files to the DRAM cache to maximize its write speed. Statistics show that for the average user's computer, more read operations than write operations are performed; thus, it will be enough for this hierarchical structure without using a large amount of DRAM cache.

Employing the plug and play USB interface and USB optimization is convenient for users and guarantees that performance will not be affected. The plug and play USB interface and USB optimization will become increasingly popular with the continued increase in USB bandwidth.

Additional creative information and elaboration of the invention (this part does not contain any new features):

The present invention can change the structure of computing and the I/O mechanism, operating mode of application, and the computer's performance.

Before the present device was developed, some patented documents were created in relation to the SLC NAND flash cache or MLC NAND flash cache, such as the patents US 20100042773 A1 and CN 101981555 A. A ReadyBoost random write cache device also exists. However, a fundamental difference exists between the purpose and working principle of these devices and the present invention. Significant differences also exist between their structure and methodology.

A. First, the purpose and working principle are different. The purpose and principles explains why earlier cache devices has no effect on computers with SSD. Comparisons are made below.

A1. The working principle is different. The cache flash, the ReadyBoost random write cache device described in Patent 20100042773 A1 and CN 101981555 A, or any other current device that uses the random performance of flash as a cache actually uses the better random read performance of NAND than a mechanical hard disk, to provide a particular type of read-write cache. Such device relies on the advantage of flash in random read speed (a high-quality flash memory is often the key to successfully achieve such purpose), but its performance in sequencial read/write and 4K is often not as good as that of the storage device of the machine itself. For this reason, such devices' speed-up effect is not obvious. The performance difference is not obvious to the user because the vast majority of the actual operation of the system I/O is either sequential or 4K. Furthermore, due to the popularity of the solid-state hard drive, such devices are losing supporters. On the contrary, the present invention is a device which built up a cache that has faster read and write speeds (including sequential r/w) and faster 4K speed than a computer hard disk. Its purpose is to redirect the disk I/O so that users can experience the difference.

A2. Solving the ‘low 4K’ problem and overcoming current industry prejudice: The 4K performance of past flash cache devices is low, and users will not be able to feel the effect. Thus, Intel Turbo or Readyboost etc no longer being discussed a lot since the development of solid-state hard drives. The key point of a computer users' experience is 4K performance and multi-threaded 4K performance. The 4K performance of flash master controller in USB architecture is low and is usually noz more than 5 MB per second. The 4K of Intel Turbo Memory using the mSATA interface is only 3 MB per second too. While the 4K speed of the SSD can generally exceeds 20 MB per second. Obviously how can low-speed equipments serve as a cache for high-speed devices. This issue also causes a long-term bias that computer performance is predetermined and that external devices cannot produce substantial changes. This bias has hampered the development of related technologies in recent years. However, the present invention overcomes this prejudice and changes the framework: With the use of triple cache (internal DRAM-onboard DRAM-SLC NAND architecture) and multi I/O channel chip architecture, the device can out perform the 4K of a SSD.

B. Second, two points in relation to structural differences between this invention and earlier devices are raised.

B1. The architectures are different. The devices described in Patents 20100042773 A1 and CN 101981555 use SLC NAND as a primary cache and MLC NAND as a secondary cache with a structure arranged in decreasing order from high to low. The present invention uses a triple-buffered parallel branch structure (FIG. 6) equipped with onboard DRAM memory and a dual-channel or multi-channel SLC NAND memory module. The device calls the cache of the host computer at a certain percentage with the use of onboard DRAM as the mapping table and a high-speed primary cache. The part from the host mimics a RAM disk store cache, generating an image file in the system tray, and then loading and saving while switching on/off. Partial SLC NAND is frequently used as read and write files and a random data cache. The rest of the SLC NAND is used as a virtual program storage mounting area. Each cache file being assigned to the most suitable caching area in accordance to its I/O properties. Below C1 shows such a parallel branch structure.

B2.The data channels are different. Previous devices are in one I/O channel. The present invention in the cache architecture employs a multi I/O channel mode. An array module integrates a plurality of SLC NAND chips and employs a multi I/O channel master controller. It has a multi-channel architecture, multi I/O channel master controller with an optional module array. The array module integrates multiple SLC NAND flash memory or 3D V-NAND chips by employing a multi I/O channel master controller, which can operate in dual-channel or multi-channel mode. An array that consists of multiple physical chips is used as a logical disk group, and data segments are stored on different physical disks in this logical disk group. When data are accessed, the related disk array works in parallel, thereby changing the speed. The conventional caching algorithm itself does not achieve parallelism in realtime; all requests are serialized. However, our device is a multi-channel parallel device. It can improve I/O performance by turning the serial I/O into parallel I/O. We use modern multi-threaded programming to turn the serial I/O into parallel I/O and use a fine-grained synchronization lock mechanism to increase the parallelism of the I/O process, thereby improving I/O performance.

C. This invention's I/O processing is different with previous products. Its innovation is also reflected in the following:

C1. Filtered and split I/O rather than direct caching, thereby increasing the user experience: A conventional caching algorithm does not distinguish between I/O types when caching disk data that cache all requests. Regardless of whether I/O is random or sequential, it often fills up the primary cache first before filling the second stage. In fact, the different channels have different advantages and disadvantages.

Furthermore, a conventional caching algorithm does not consider user habits. In fact, users often use read operations more than write operations. The present invention takes advantage of the different characteristics of DRAM and SLC NAND in multi-channel mode for task assignment. The process is described in detail as follows (including the case of claim 9): Considering that the write operation consumption of flash memory is approximately eight times the consumption of the read operation and that the read operation is usually higher than the write operation for ordinary users, the write operations cache, especially the small file write operations cache, is assigned into the DRAM cache. Write operations, such as web browsing, are assigned to the DRAM cache. Read operations cache, especially random read operations such as loading game programs, are assigned to the NAND cache, thereby improving user experience. Users can also conduct their own manual intervention according to their type by using the console.

C2. I/O redirection and bypass the hard disk (claim 10): Claim 10 describes the mode of operation of the device in extreme cases. In extreme cases, such as when the I/O performance of the original computer is too low, the device will load the operating system that is pre-stored in the device and redirect all applications to the device, completely bypassing the original system and disk to obtain a high-speed experience. The concept of redirection is already used in security sandbox anti-virus software but is different from the present invention in terms of technology and working methods. It also has completely different purposes and functions.

1. The developed electronic device features a plug and play USB (universal serial bus) interface and comprises a main controller chip and at least one SLC NAND module (or iSLC which simulates SLC working conditions with the MLC NAND module through a specific flash management algorithm, for example, by reprograming the 2-bit per cell of the MLC NAND to a 1-bit per cell.)
Essentially, the device functions with two core characteristics.
First, when the device is connected to a computer via its USB interface, it then creates a cache file in the SLC NAND modules. This cache file may cache common system and application files of the computer, and pre-read frequently used small files and random data, taking advantage of high-speed random access and fast r/w speed, reducing the access of the hard drive to provide acceleration and improve I/O performance.
Second, the device uses a DRAM cache. The DRAM cache may be used by employing any of the following methods: (1) setting a DRAM cache in the device as a data mapping table and data cache, such as 1 MB of DRAM cache mapping 1 GB of SLC NAND; (2) dividing part of the computer memory available to establish cache and integrating this high-speed cache and the SLC NAND cache together to take advantage of the different characteristics of the DRAM and SLC NAND module and thereby achieve better task assignment.
Moreover, the device uses the following Multi I/O channel architecture design:
Multi I/O channel design. An array module integrates an array of SLC NAND chips and employs a main controller chip, which can be a multi-channel IC architecture or uses more than one main controller. An optional array module can also be used. The array module integrates multiple SLC NAND flash memories or 3D V-NAND chips, and employs multi-channel main controller, which can be operated in dual- or multi-channel mode, for example, such an array consisting of multiple physical chips forms as a logical disk group, and data segments are stored on different physical chips/disks in this logical disk group. When data access is needed, the related chips/disks in the array function in a parallel manner to improve speed.

2. A device based on that described in claim 1 features an algorithm and architecture with the following design. The device virtualizes applications to pre-store all program files and program system environment in the device. Acceleration is achieved with A+B:
A. Cache acceleration: According to claim 1, the device takes advantage of the differences between DRAM and SLC NAND in a multi-channel mode to achieve good task assignment.
B. Application acceleration: The device virtualizes applications (originally on a hard disk) into the device to transfer, read, and write from the device. There are several virtualization principles for consideration, such as redirecting registry and environmental files in order to pre-store all program files and program system environment files into the device. When the device executes the main program file, the operation involved is completed in this virtual environment without accessing the original system. Thus, after processing, all files being called are stored in the application directory, which is located in the SLC NAND flash memory module. The files are not used from the hard disk, thus avoiding hard disk read and write.

3. A device based on claim 1 employs a complex triple caching mechanism (as shown in FIG. 6) and is equipped with onboard DRAM memory and a dual-channel or multi-channel SLC NAND memory module. In addition, the DRAM cache configures a certain percentage of the device DRAM cache and a certain percentage of the host computer memory. It mimics the RAM disk to store cache and turns the DRAM into a mapping table and a high-speed cache, the partial SLC NAND into a cache of random data and frequently read and written files, and the remaining SLC NAND into a mounting and storage area for the virtualization program.

4. A device based on that described in claim 1 features an algorithm and architecture with the following design. The device identifies and monitors the long-term habits of users, determines which data the system is about to use, and pre-stores the data into the device according to claim 1. In this way, the data can be directly retrieved from the device and then transferred into memory or CPU to reduce hard disk read and writes.

5. A device based on claim 1 comprises multiple SLC modules for parallel computing, as well as multiple main controller ICs.

6. A device based on claim 1 adopts the following double cache design: In addition to the SLC NAND flash memory, the device features an MLC NAND flash module. Thus, the SLC NAND flash memory acts as an L1 cache module, and the MLC NAND flash memory module acts as an L2 cache.

7. A device based on claim 1 is characterized as follows. The device modifies the transport protocol after being connected to a computer. Besides improving USB protocol by optimizing the BOT protocol, which hinders fast data transfer in traditional USB interface protocols and multitasking transmissions of NCQ, this modified USB protocol also allocates a larger amount of system resources to the USB device, provides intelligent compression, and automatically releases resources in the background.

8. A device based on claim 1 is characterized as follows. The SLC NAND work area is divided into two portions, namely, the cache area and the area storing program for acceleration, which are separated logically.

9. A device based on claim 1 is characterized as follows. The device performs the selective processing of the I/O. For example, the console can selectively load one of the channels. In another example, it can also configure the write cache, especially small file write cache to DRAM caches, including web browsing. It can configure the read cache, particularly the random read cache to the NAND cache, such as loading a program, game, and so on (the conventional caching algorithm does not distinguish the I/O type when caching disk data, that is, it caches all requests regardless of whether I/O is random or sequential, what size, read or write; this is not good because in fact the SLC NAND cache performs best in random read I/O).

10. A device based on claim 1 is characterized as follows. The device features a plug and play operating system and can start an operating system pre-installed in its non-volatile memory area by setting the BIOS from the USB interface without using the original operating system of the computer. It can also virtualize computer applications, including redirecting registries and environment files. When running systems loaded from the device and virtualized application in the device, it most thoroughly avoids the hard disk reads and writes. The original hard disk of the computer is in the bypassed state.
